(19) United States
(12) Patent Application Publication
(10) Pub. No.: US 2008/0228900 A1
(43) Pub. Date: Sep. 18, 2008

(54) Method and system for facilitating the transfer of a computer file

(75) Inventors: Josh Gorin, Glendale, CA (US); William McArdle, Glendale, CA (US); Frank Mezzatesta, Glendale, CA (US)

Correspondence Address: DISNEY ENTERPRISES;C/O FARJAMI & FARJAMI LLP, 26522 LA ALAMEDA AVENUE, SUITE 360, MISSION VIEJO, CA, 92691, US

(73) Assignee: Disney Enterprises, Inc.

(21) Appl. No.: 11/724,463

(22) Filed: Mar. 14, 2007

(51) Int. Cl. G06F 15/16

(52) U.S. Cl. 709/219

(57) ABSTRACT

There is provided a method for use by a server for facilitating a transfer of a computer file from a first computer to a second computer. The method comprises receiving the computer file and correspondence information from the first computer, generating a transaction code associated with the receiving the computer file and the correspondence information, creating a storage file associated with the transaction code in a storage device in communication with the server, storing the computer file in the storage device using the storage file, sending a notification message having the transaction code to the second computer, receiving the transaction code from the second computer for retrieving the computer file, locating the storage file associated with the transaction code, retrieving the computer file from the storage device, transmitting the computer file retrieved from the storage device to the second computer.

### BACKGROUND OF THE INVENTION

1. Field of the Invention

The present invention relates generally to techniques for transferring a computer file. More particularly, the present invention relates to facilitating the transfer of a computer file from one computer to another computer over a network.

2. Background Art

Computer files can typically be transferred from one computer to another using one of several known methods. For example, a computer file residing in one computer can be sent to another computer using a suitable e-mail protocol, such as Simple Mail Transfer Protocol (SMTP). As another example, one computer can be connected to another computer over a network, such as the Internet, thereby allowing the transfer of computer files using file transfer protocol (FTP). More commonly, one computer can transfer computer files to another computer over a local network by using a local file server, for example.

The abovementioned methods, however, either are not suitable for transferring of large computer files, e.g., e-mailing computer files exceeding 10 megabytes, or are quite inconvenient, such as the setup and login procedures for the FTP process. For example, conventional e-mail systems typically impose severe limitations on the size of the computer files that can be transferred from one computer to another. Moreover, conventional e-mail systems typically limit the storage space allocated to each e-mail account. To circumvent these problems, users are usually forced to break up large computer files into smaller computer files and to send each smaller computer file individually. However, such a process can be time consuming and unreliable. Furthermore, even if the smaller computer files can be sent individually, the limited storage space allocated to each e-mail account is typically exceeded before all of the smaller computer files are received.

The transfer of large computer files using FTP also presents significant drawbacks. In particular, an FTP server must be implemented and maintained, which typically requires extensive client setup and specialized software, the use of which can be difficult to learn. Consequently, such a system is not suitable for novice or casual users wishing to transfer large computer files from one computer to another computer. The use of a local file server presents similar problems and further limits the transfer of computer files only between computers having access to the local file server.

Thus, there is a strong need in the art for methods and systems that allow the convenient transfer of a computer file from one computer to another computer.

### SUMMARY OF THE INVENTION

There is provided methods and systems for facilitating the transfer of a computer file, substantially as shown in and/or described in connection with at least one of the figures, as set forth more completely in the claims.

### BRIEF DESCRIPTION OF THE DRAWINGS

The features and advantages of the present invention will become more readily apparent to those ordinarily skilled in the art after reviewing the following detailed description and accompanying drawings, wherein:

FIG. 1A illustrates a diagram of a system for facilitating the transfer of a computer file, in accordance with one embodiment of the present invention;

FIG. 1B illustrates a block diagram of a server in the system of FIG. 1A, in accordance with one embodiment of the present invention;

FIGS. 2A and 2B illustrates an example file transaction process, in accordance with one embodiment of the invention; and

FIGS. 3A and 3B illustrate a flowchart for performing an example method for transferring a computer file from a first computer to a second computer, in accordance with one embodiment of the present invention.

### DETAILED DESCRIPTION OF THE INVENTION

Although the invention is described with respect to specific embodiments, the principles of the invention, as defined by the claims appended herein, can obviously be applied beyond the specifically described embodiments of the invention described herein. Moreover, in the description of the present invention, certain details have been left out in order to not obscure the inventive aspects of the invention. The details left out are within the knowledge of a person of ordinary skill in the art.

The drawings in the present application and their accompanying detailed description are directed to merely example embodiments of the invention. To maintain brevity, other embodiments of the invention which use the principles of the present invention are not specifically described in the present application and are not specifically illustrated by the present drawings. It should be borne in mind that, unless noted otherwise, like or corresponding elements among the figures may be indicated by like or corresponding reference numerals.

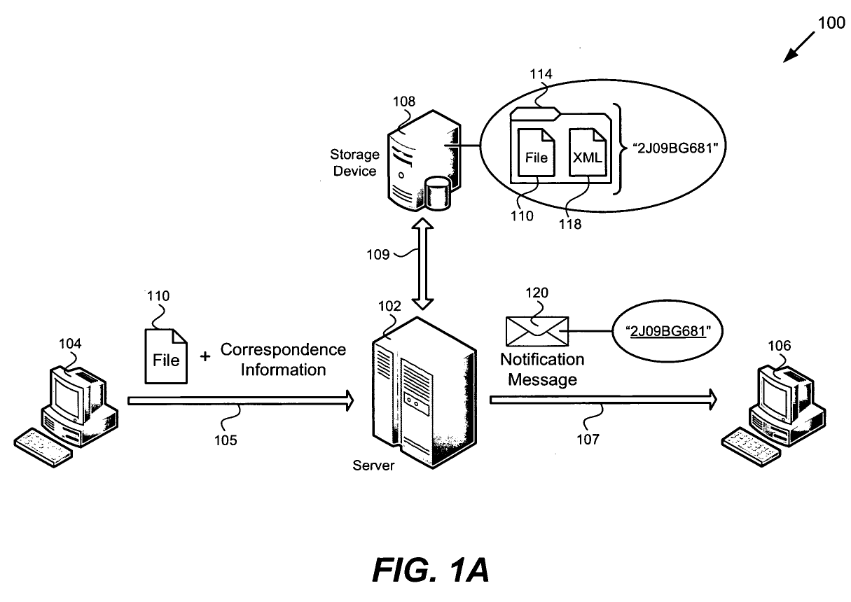

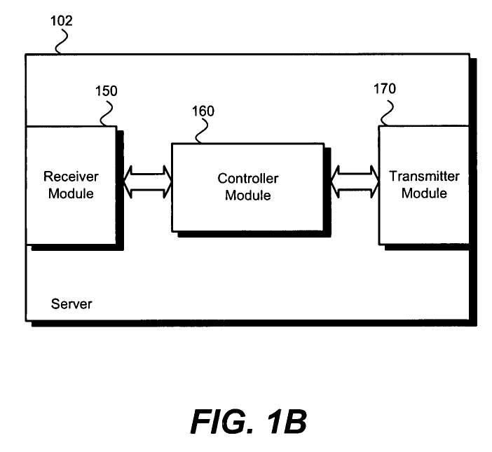

FIG. 1A illustrates a diagram of a system for facilitating the transfer of a computer file in accordance with one embodiment of the present invention. As shown in FIG. 1A, system 100 includes server 102, first computer 104, second computer 106, and storage device 108.

As shown in FIG. 1A, first computer 104 and second computer 106 are in communication with server 102 via respective data paths 105 and 107. First computer 104 and second computer 106 can each be, for example, a desktop or laptop computer, or any other computer capable of accessing a network, such as the Internet. For example, data paths 105 and 107 can each be a physical connection, such as a physical communication bus, or a wireless connection, such as a wireless local area network (LAN) connection. Server 102 can be a Web server that can be accessed via the Internet and can have one or more domain names. As shown in FIG. 1A, server 102 is in communication with storage device 108 via data path 109. Storage device 108 can be a logical drive situated inside server 102 or a physical drive situated either inside or outside server 102. In a preferred embodiment, storage device 108 is isolated from first computer 104 and second computer 106, such that first computer 104 and second computer 106 cannot directly access storage device 108.

FIG. 1B illustrates a block diagram of server 102 shown in FIG. 1A in accordance with one embodiment of the present invention. As shown in FIG. 1B, server 102 includes receiver module 150, controller module 160, and transmitter module 170. As further shown in FIG. 1B, receiver module 150 and transmitter module 170 are in communication with controller module 160. For example, receiver module 150, controller module 160, and transmitter module 170 can each be implemented in hardware or software.

In one embodiment, controller module 160 of server 102 in FIG. 1B can be an Apache HTTP server capable of serving a file transfer application on the Internet. As discussed below, the file transfer application can include an HTML form that can be used for inputting a computer file, such as computer file 110, and correspondence information associated with delivery of the computer file. For example, a user of first computer 104 in FIG. 1A who wishes to send computer file 110 to a user of second computer 106 can use the file transfer application to input one or more files and correspondence information, which can include for example, an address of the recipient (e.g., the e-mail address of the user of second computer 106), an address of the sender (e.g., the e-mail address of the user of first computer 104), and an optional note. As shown in FIG. 1A, computer file 110 and the correspondence information can then be transmitted to and received by server 102 at receiver module 150 via data path 105. In one embodiment, computer file 110 and the correspondence information can then be transmitted using a Transport Layer Security (TLS) protocol or a Secure Sockets Layer (SSL) protocol.

Upon receiving computer file 110 and the correspondence information, controller module 160 of server 102 can perform a validation process to ensure that the file transfer application was properly used. For example, the validation process can be implemented using a server-side script which can verify proper syntax in the e-mail addresses provided by the user of first computer 104, as well as verifying that at least one computer file was inputted by the user of first computer 104. Moreover, controller module 160 can be configured to perform a security check to prevent unauthorized parties from using the file transfer application. For example, the security check can be implemented using a server-side script which can analyze the e-mail domain names in the correspondence information and grant access to a user only if one or more of the e-mail domain names are recognized by controller module 160.

In one embodiment, controller module 160 of server 102 can be configured to store the computer file and the correspondence information in a temporary file in server 102 and can be configured to generate a transaction code. The transaction code, for example, can be a randomly generated alphanumeric code that can be varied in length. In other embodiments, the transaction code can be generated using a cryptographic hash function, e.g., Message-Digest algorithm 5 (MD5), and thus can be an encrypted hash of an alphanumeric string that includes data about the file transfer transaction. For example, the transaction code can be an encrypted alphanumeric string that includes data in a particular sequence, such as the date of the transaction followed by an encryption key for the computer file discussed below. Controller module 160 can be further configured to verify that the generated transaction code is not presently in use and to generate a new transaction code if it is presently in use.

Controller module 160 of server 102 can be configured to create a storage file in storage device 108, such as storage file 114, and to store the received computer file, i.e., computer file 110, in the storage file. In one embodiment, computer file 110 can be encrypted by controller module 160 using encryption methods known in the art, prior to storing computer file 110 in storage file 114. In another embodiment, computer file 110 can be compressed using file compression methods known in the art in order to conserve storage space in storage device 108. Controller module 160 can then associate the transaction code described above with the storage file. As shown in FIG. 1A, for example, storage file 114, i.e., the storage file in which computer file 110 to be transferred is stored, can be associated with a transaction code, such as “2J09BG681.” For example, the transaction code “2J09BG681” can be assigned as the name of storage file 114, while computer file 110 in storage file 114 retains its original name. In other embodiments, the abovementioned transaction code can be configured to reference the location of storage file 114. For example, the transaction code may be associated, e.g., in a database, with a file path indicating the location of storage file 114, thereby allowing the name of storage file 114 to remain unaltered. In still other embodiments, the transaction code may include encrypted information, such as a name or location, i.e., a file path, of storage file 114, which can later be decrypted to determine the name or location of storage file 114.

Controller module 160 can be further configured to generate a data file, which can include various information about the file transfer transaction, such as the name of the sender, the name of the recipient, the size and type of the computer file received by server 102 at receiver module 150, and an expiration date. The expiration date can be used, for example, to automatically delete storage file 114 from storage device 108 if computer file 110 is not retrieved before the expiration date. For example, the data file can be generated in the Extensible Markup Language (XML) format, or other suitable file format. The data file, such as data file 118 shown in FIG. 1A, can also be stored in storage file 114 by controller module 160.

As shown in FIGS. 1A and 1B, controller module 160 of server 102 can be further configured to send a notification message to the recipient's computer, i.e., second computer 106, via data path 107 using transmitter module 170. For example, the notification message, such as notification message 120, can be an e-mail message which includes the transaction code and a hyperlink, i.e., a Uniform Resource Locator (URL), which provides access to a Web page served by server 102 for retrieving the computer file. In one embodiment, controller module 160 can be configured to send a notification message to both the sender and the recipient. As shown in FIG. 1A, for example, notification message 120 can include the transaction code “2J09BG681” as a hyperlink. In the embodiment where computer file 110 is encrypted prior to being stored in storage file 114 discussed above, controller module 160 can be configured to include the proper decryption key in the notification message in addition to the transaction code. Controller module 160 of server 102 can be configured to also send a delivery receipt to the sender's computer, i.e., first computer 104, to notify the sender that delivery of the computer file to the recipient, i.e., second computer 106, was successful.

Once the recipient has received notification message 120, the recipient can use the transaction code included therein to receive the computer file stored in storage file 114. For example, second computer 106 can be configured to transmit the transaction code to server 102 and server 102 can be configured to receive the transaction code using receiver module 150. Controller module 160 can then verify whether the code is valid, e.g., that the code contains a proper alphanumeric sequence. In other embodiments, controller module 160 can be configured to validate the transaction code by decrypting the transaction code and by detecting whether the transaction code includes the proper sequence of data relating to the file transfer transaction, e.g., the date of the transaction, the name or location of the storage file, and the encryption key for the computer file to be transferred. Controller module 160 can be further configured to then search storage device 108 to locate the storage file associated with the transaction code. In the embodiment shown in FIG. 1A, for example, the recipient may click the hyperlink included in notification message 120 to access a Web page served by server 102 for retrieving computer file 110. For example, the transaction code “2J09BG681” can be automatically passed to receiver module 150 through the Web page and can be verified by controller module 160 as discussed above. After verifying the transaction code, controller module 160 can be configured to access storage device 108 and to determine the computer files in the storage file, i.e., storage file 114, associated with the transaction code “2J09BG681” and to display the names of the computer files on the Web page.

The recipient may then request to download one or more of the computer files displayed on the Web page by clicking a “download” button situated next to each named computer file. Upon receiving a download request, controller module 160 of server 102 can be configured to use a server-side script, which can be implemented using Hypertext Preprocessor (PHP), that locates the storage file in storage decvice 108 associated with the transaction code. As shown in FIG. 1A, for example, when the recipient requests to download computer file 110, the server-side script used by controller module 160 first locates the storage file in storage device 108 associated with the transaction code “2J09BG681,” such as storage file 114, and then determines whether computer file 110 is actually in storage file 114. Controller module 160 then uses the server-side script to retrieve computer file 110 from storage device 108 via data path 109. Once retrieved, computer file 110 can be further processed by controller module 160, for example, by injecting various headers into computer file 110, which can prompt the recipient as to whether the files are to be opened immediately or saved to a local storage device in the recipient's computer, i.e., second computer 106. The computer file is then streamed to the recipient, i.e., second computer 106, through transmitter module 170 using another server-side script. Thus, it should be noted that in the embodiment of the invention shown in FIG. 1A, neither first computer 104 nor second computer 106 has direct access to storage device 108. By using a server-side script as a vehicle for transferring computer files to and from storage device 108, storage device 108 can remain isolated from computers accessing server 102, thus preserving the security of the content stored in storage device 108.

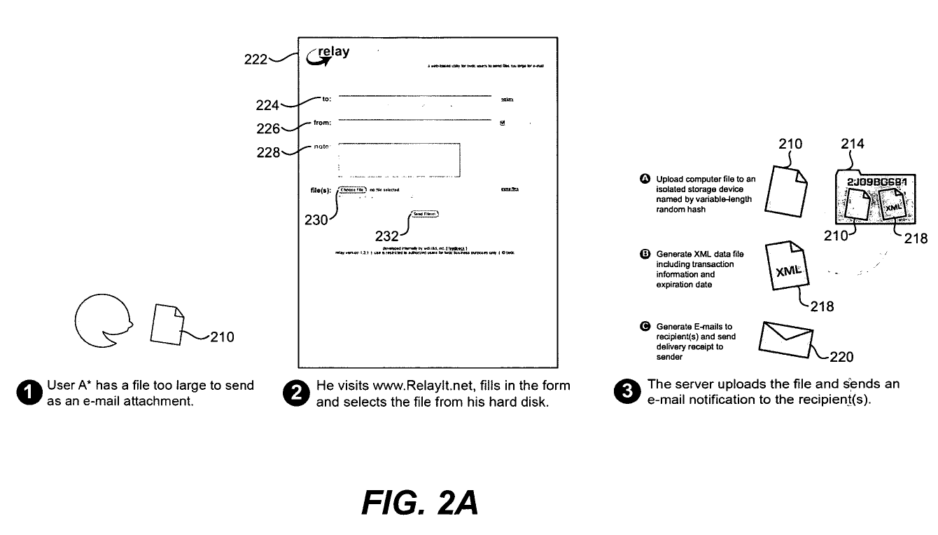

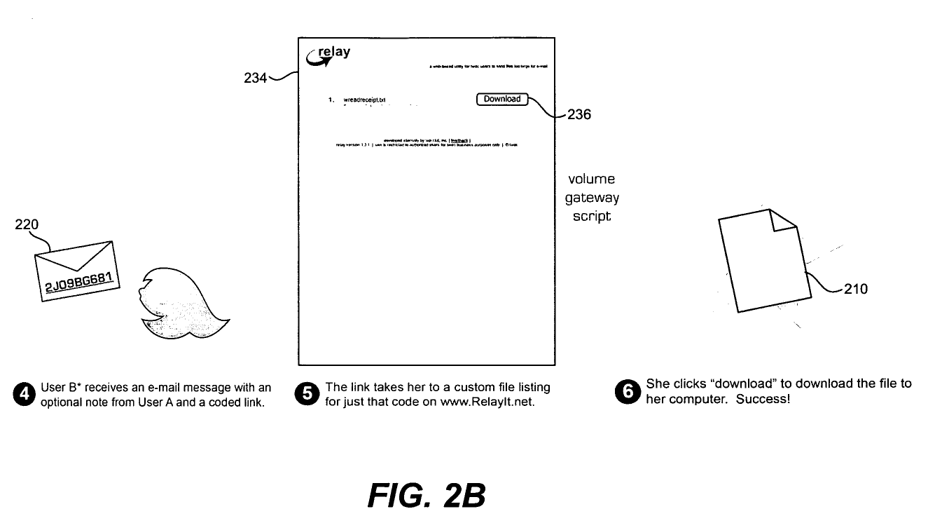

FIGS. 2A and 2B illustrate an example file transaction process in accordance with one embodiment of the invention. As shown in FIG. 2A, at step 1, user “A” has computer file 210, which he would like to send to user “B.” Computer file 210, for example, can be a computer file, which is too large to send as an e-mail attachment. At step 2, user A accesses the file transfer application served by server 102, by entering the appropriate URL, such as “www.RelayIt.net,” in a Web browser. As discussed above, the file transfer application can include an HTML form, such as form 222. User A can use form 222 to input correspondence information that can be used to transfer the computer file to user B. For example, user A can input the e-mail address of user B in text field 224, the email address of user A in text field 226, and an optional note in text field 228. In other embodiments, user A can send computer file 210 to additional recipients by listing their e-mail addresses in addition to user B's e-mail address.

User A can then select a “choose file” button, such as choose file button 230, to select computer file 210, which might be stored locally on user A's hard drive. In other embodiments, computer file 210 can be selected using a drag-and-drop method known in the art. In yet another embodiment, an entire folder can be selected, wherein the folder can contain computer file 210 in addition to other computer files. If more than one server is available, for example, form 222 can be configured to allow user A to select the particular server to which the computer file will be sent and stored to facilitate downloading of the computer file by user B. Form 222 can also be configured to display a progress bar indicating the progress of the file transfer to server 102, which can be implemented, for example, with plug-in software that can be used by the Web browser or with dynamic Web scripting tools known in the art, such as “Ajax.” It should be noted that, in one embodiment, user A sets a password that may or may not be used as the file's encryption key, but it can prevent the recipient from receiving or accessing the file without the password.

After filling out the appropriate fields in form 222 in FIG. 2A, user A can select a “send file(s)” button, such as send file button 232 in form 222 to transfer computer file 210 to the server, such as server 102 FIG. 1A. At step 3 in FIG. 2A, a transaction code is generated for the file transfer transaction, such as “2J09BG681,” and a storage file is created in a storage device, such as storage device 108 in FIG. 1A. An XML data file can also be generated by the server, such as XML data file 218, which can include various information about the file transfer transaction, such as the name of the sender, the name of the recipient, the size and type of the computer file received by the server, and an expiration date. As shown in FIG. 2A, the transaction code is associated with storage file 214. As also shown in FIG. 2A, computer file 210 and XML data file 218 are uploaded and stored in storage file 214. As further shown in FIG. 2A, an e-mail notification, such as e-mail notification 220, is sent to each of the recipients listed in text field 224, i.e., user B, and a delivery receipt is sent to the sender, i.e., user A.

Referring now to FIG. 2B, at step 4, user B receives the e-mail notification, such as e-mail notification 220, sent at step 4 in FIG. 2A. E-mail notification 220 can include the transaction code, i.e., “2J09BG681,” and a hyperlink used to access a Web page for retrieving the computer file, such as retrieval page 234 shown in step 5. At step 6, user B can choose the specific file to be downloaded and may proceed to download the computer file by clicking a “download” button situated next to the computer file, such as download button 236 in retrieval page 234. A server-side script can then be initiated, which first locates the storage file associated with the transaction code “2J09BG681,” such as storage file 214, and then determines whether computer file 210 is actually in storage file 214. The server-side script then enables the server to retrieve computer file 210 from the storage device, thereby enabling another server-side script to stream computer file 210 to the recipient, i.e., user B.

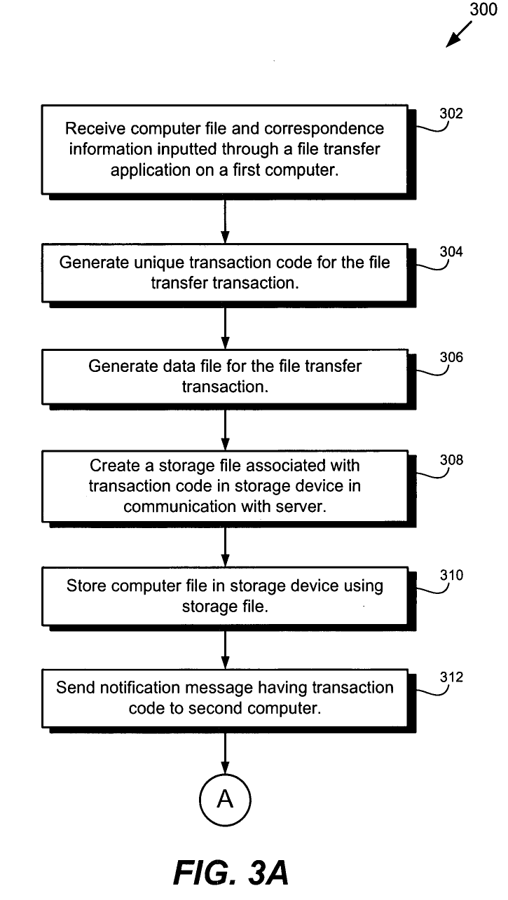

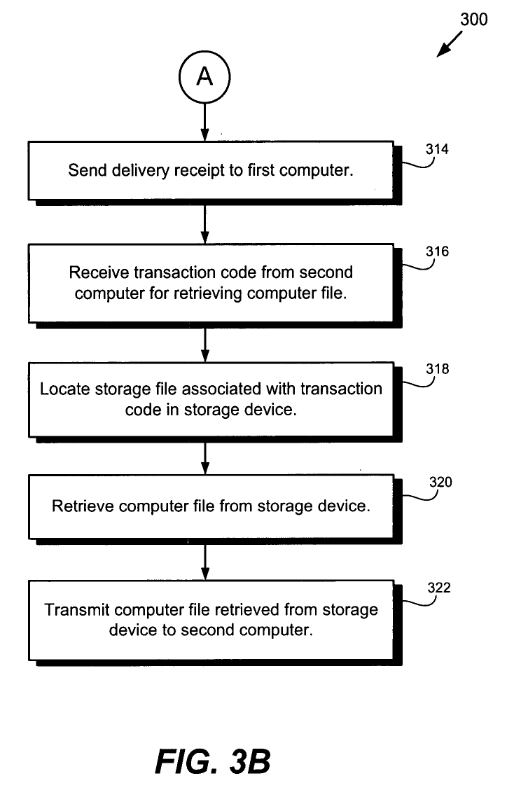

FIGS. 3A and 3B illustrate flowchart 300 for performing an example method for transferring a computer file from a first computer to a second computer in accordance with one embodiment of the present invention. With reference to the embodiment of the invention shown in FIG. 1A and as shown in FIG. 3A, at step 302 of flowchart 300, a computer file and correspondence information inputted through a file transfer application on a first computer are received by server 102. At step 304, a unique transaction code for the file transfer transaction is generated. At step 306, a data file for the file transfer transaction is generated. Then, at step 308, a storage file associated with the transaction code is created in a storage device, such as storage device 108, which is in communication with server 102. At step 310, the computer file is stored in the storage device using the storage file. In one embodiment, the server may also request the file password, if any.

At step 312, a notification message having the transaction code is sent to the second computer. Referring now to FIG. 3B, at step 314, a delivery receipt is sent to the recipient at the first computer. At step 316, the transaction code is received from the second computer for retrieving the computer file. At step 318, the storage file associated with the transaction code is located in the storage device. At step 320, the computer file is retrieved from the storage device. Then, at step 322 the computer file retrieved from the storage device is transmitted to the second computer.

From the above description of the invention it is manifest that various techniques can be used for implementing the concepts of the present invention without departing from its scope. Moreover, while the invention has been described with specific reference to certain embodiments, a person of ordinary skill in the art would recognize that changes can be made in form and detail without departing from the spirit and the scope of the invention. For example, it is contemplated that the circuitry disclosed herein can be implemented in software, or vice versa. The described embodiments are to be considered in all respects as illustrative and not restrictive. It should also be understood that the invention is not limited to the particular embodiments described herein, but is capable of many rearrangements, modifications, and substitutions without departing from the scope of the invention.

What is claimed is:

1. A method for use by a server for facilitating a transfer of a computer file from a first computer to a second computer, said method comprising:
receiving said computer file and correspondence information from said first computer;
generating a transaction code associated with said receiving said computer file and said correspondence information;
creating a storage file associated with said transaction code in a storage device in communication with said server;
storing said computer file in said storage device using said storage file;
sending a notification message having said transaction code to said second computer;
receiving said transaction code from said second computer for retrieving said computer file;
locating said storage file associated with said transaction code;
retrieving said computer file from said storage device;
transmitting said computer file retrieved from said storage device to said second computer.

2. The method of claim 1 wherein said storage device is isolated from said first computer and said second computer.

3. The method of claim 1 wherein said correspondence information includes an address of a recipient, an address of a sender, and a note from said sender.

4. The method of claim 1 further comprising generating a data file after said generating said transaction code, wherein said data file includes a name of said sender, a name of said recipient, a size and a type of said computer file, and an expiration date.

5. The method of claim 1 further comprising sending a delivery receipt to said first computer after said sending said notification message.

6. The method of claim 1 wherein said notification message comprises an e-mail message.

7. The method of claim 1 further comprising encrypting said computer file prior to storing said computer file in said storage device.

8. A server for facilitating a transfer of a computer file from a first computer to a second computer, said server comprising:
a receiver configured to receive said computer file and correspondence information from said first computer;
a controller configured to generate a transaction code and to create a storage file associated with said transaction code in a storage device in communication with said server, and further configured to store said computer file in said storage device using said storage file;
a transmitter configured to transmit a notification message having said transaction code to said second computer;
wherein said receiver is further configured to receive said transaction code from said second computer, and wherein said controller is further configured to locate said storage file associated with said transaction code and to retrieve said computer file from said storage device, and wherein said transmitter is configured to transmit said computer file retrieved from said storage device to said second computer.

9. The server of claim 8 wherein storage device is isolated from said first computer and said second computer.

10. The server of claim 8 wherein said correspondence information includes an address of a recipient, an address of a sender, and a note from said sender.

11. The server of claim 8 wherein said controller is further configured to generate a data file including a name of a sender, a name of a recipient, a size and a type of said computer file, and an expiration date.

12. The server of claim 8 wherein said controller is further configured to send a delivery receipt to said first computer.

13. The server of claim 8 wherein said notification message comprises an e-mail message.

14. The server of claim 8 further comprising encrypting said computer file prior to storing said computer file in said storage device.

15. A system for facilitating a transfer of a computer file, said system comprising:
a first computer and a second computer;
a storage device; and
a server, said server including:
a receiver configured to receive said computer file and correspondence information from said first computer;
a controller configured to generate a transaction code and to create a storage file associated with said transaction code in a storage device in communication with said server, and further configured to store said computer file in said storage device using said storage file;
a transmitter configured to transmit a notification message having said transaction code to said second computer;
wherein said receiver is further configured to receive said transaction code from said second computer, and wherein said controller is further configured to locate said storage file associated with said transaction code and to retrieve said computer file from said storage device, and wherein said transmitter is configured to transmit said computer file retrieved from said storage device to said second computer.

16. The system of claim 15 wherein storage device is isolated from said first computer and said second computer.

17. The system of claim 15 wherein said correspondence information includes an address of a recipient, an address of a sender, and a note from said sender.

18. The system of claim 15 wherein said controller is further configured to generate a data file including a name of a sender, a name of a recipient, a size and a type of said computer file, and an expiration date.

19. The system of claim 15 wherein said controller is further configured to send a delivery receipt to said first computer.

20. The system of claim 15 wherein said notification message comprises an e-mail message.
